(19) United States
(12) Patent Application Publication
(10) Pub. No.: US 2007/0124810 A1
(43) Pub. Date: May 31, 2007

(54) Method and system for securing electronic transactions

(76) Inventor: Ian David Sigalow, New York, NY (US)

Correspondence Address: JONES DAY, 222 EAST 41ST ST, NEW YORK, NY, 10017, US

(21) Appl. No.: 11/290,888

(22) Filed: Nov. 29, 2005

(51) Int. Cl. H04L 9/32

(52) U.S. Cl. 726/9

(57) ABSTRACT

Methods and systems for securing electronic transactions. In a preferred embodiment, a variable-display credit card, wherein the indicia of the variable display are utilized to create a validation packet, which can be processed by a remote network operations center to correlate the account holder to the credit card variable display, thereby validating the user making the transaction.

### FIELD OF THE INVENTION

The field of the invention is methods and systems for securing electronic transactions. In a preferred embodiment, the invention relates to a variable-display credit card, wherein the indicia of the variable display are utilized to create a validation packet, which can be processed by a remote network operations center to correlate the account holder to the credit card variable display, thereby validating the user making the transaction.

### BACKGROUND OF THE INVENTION

As technology has enabled people to purchase goods and services remotely, especially utilizing the Internet, and to overall conduct electronic transactions with greater proficiency, the rate and risk of fraudulent purchases has also increased. Internet transactions are remote transactions, in that a credit card user is not present in person to make the transaction—instead, the user submits information to the seller to serve as proof of true identification of the user. Moreover, because credit card and account numbers may simply be copied, and therefore even the credit card itself may not need to be present to enter in its information, credit card fraud over the Internet is extremely hard to control.

Similar problems have been identified in remote log-in services, where, for example, an employee of a company can access his/her company's database, documents, email, etc. from a remote location via the Internet. To address log-in fraud problems, there are currently products available, such as RSA's® key fob token, which generates a rotating number SecureID™ password that the user must enter, in addition to other fixed information such as user name and password, to access such a database. This system has also been adapted for online stock trading applications, such as E-Trade®.

However, the system disclosed and marketed by RSA® is not suitable for large-scale credit card transactions. The RSA® system also fails to provide any form of gatekeeping function, and does not inspect packets of data for information. Thus, there is no authentication mechanism in the RSA® system other than rotating numbers.

The goal of the present invention to improve upon these, and other deficiencies is systems such as the RSA® system, to create an efficient and secure identification and authentication system for remote user transactions.

### SUMMARY OF THE INVENTION

A method of verifying user information is described, comprising the steps of: submitting the user information, wherein the user information comprises a variable password; transmitting the user information to a processing server; generating an authentication password based at least in part on provided information; and comparing the variable password to the authentication password.

Generation of the authentication password may be prompted by the processing server receiving the user information. The user information may further comprise a fixed password. The user information may further comprise a time/date stamp. The variable password may be generated by a processor. The processor may be housed in a credit card. The user information may be submitted by a user remotely located from the processing server. The user information may be at least partially comprised of information not processed by the processing server. The user information may be submitted using a computer.

Another method of verifying user information is described, comprising the steps of: submitting the user information, wherein the user information comprises a variable password generated by a processor; transmitting the user information to a processing server; and comparing the variable password to an authentication password, wherein the authentication password is maintained independent of the processor.

The variable password and the authentication password may be synched prior to the step of submitting the user information. The processor may be connected to a clock configured to prompt the processor to generate a variable password. The clock may prompt the processor at a first frequency. The authentication password may be generated at the first frequency. The first frequency may be predetermined.

A system for verifying user information is described, comprising: a user element capable of generating a variable password; a processing server capable of generating an authentication password based at least in part on provided information; a connection configured to transmit the variable password to the processing server; wherein the provided information comprises at least information correlating to the date and time a user transaction was submitted.

The user element may be a credit card. The user element may comprise a processor. The authentication password may be generated independent of the user element. The authentication password may be generated upon the processing server receiving the variable password. The variable password and the authentication password may be generated concurrently. The authentication password may be stored in memory. The information correlating to the date and time a user transaction was submitted may be provided by the user element.

A credit card is described comprising: a display having a plurality of indicia; a processor; and a clock; wherein the processor is connected to the display and the clock; wherein the processor is capable of generating a variable password based at least in part on information provided by the clock; and wherein the display is capable of displaying the variable password.

The credit card may further comprise a crystal connected to the clock. The crystal may oscillate at a substantially constant frequency. The clock may be prompted to provide information to the processor based at least in part on the oscillation of the crystal. The credit card may further comprise at least one battery. The variable password may be regenerated.

### BRIEF DESCRIPTION OF THE DRAWINGS

While preferred features of the present invention may be disclosed in the accompanying illustrative, exemplary drawings, for the purposes of description, the invention as defined by the claims should be in no way limited to such preferred features or illustrative and exemplary drawings, wherein:

FIG. 1 is an exemplary schematic of a standard credit card purchasing system;

FIG. 2 is an embodiment of a user verification system utilizing a network operations center;

FIG. 3 is a detailed schematic a portion of the user verification system of FIG. 2;

FIG. 4A is an embodiment of a credit card for use with the system of FIG. 2;

FIG. 4B is a detailed embodiment of the electronic elements that may be use with the credit card of FIG. 4A;

FIG. 5 is another embodiment of a user verification system utilizing a network operations center; and

FIG. 6 is another embodiment of a user verification system utilizing a network operations center.

### DETAILED DESCRIPTION OF THE PREFERRED EMBODIMENTS

While many of the examples and embodiments described herein are in reference to using credit cards or equivalents for purchasing goods or services remotely, it is expressly contemplated that the invention herein described is not limited as such. Various other applications are expressly contemplated, and will be appreciated by those of skill in the art. Such other applications for the invention herein described include government-issued identification cards.

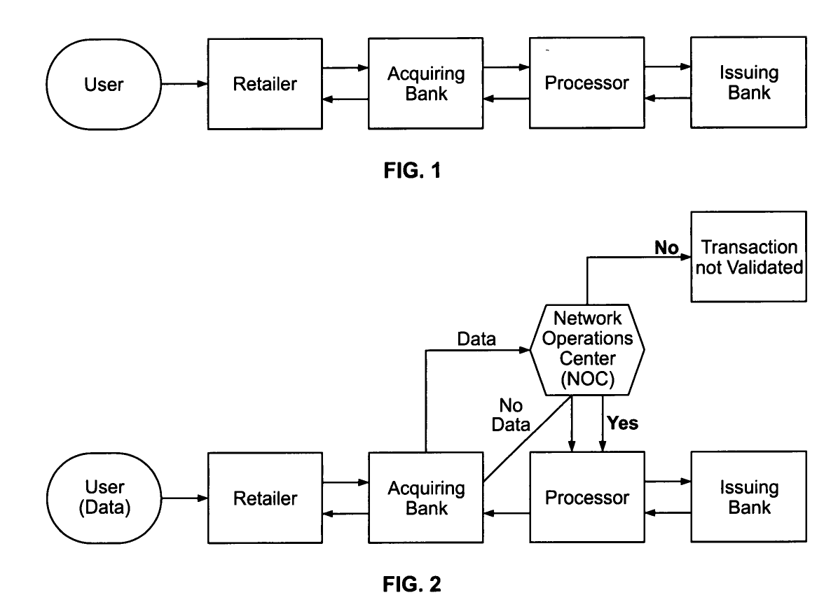

FIG. 1 shows a schematic of an exemplary standard credit card system. The first step in this process is a user making a credit card purchase at a retailer. Next, the retailer routes the data to its acquiring bank, who is responsible for settling the transfer of funds to the retailer, which normally happens at the end of every business day. After the acquiring bank receives the purchase request from the retailer, it routes the request to a processor. The processor compiles a system of records for the issuing bank and handles the monthly billing process. When the processor receives the request for purchase, it records the data and routes that information on to the issuing bank, which is the consumer's credit card issuer.

The issuing bank receives three pieces of information: the T&E (Travel & Entertainment) code of the point of sale (broad purchase category), the credit card number, and the dollar value of the purchase. If the purchase amount falls within the customer's line of credit, the purchase is generally approved. Once the transaction is approved, the data flows back along the same path all the way to the retailer. This whole process takes 2-4 seconds.

The issuing banks have an unenviable position in this network. They are three steps removed from the point of sale, receive very limited purchase information regarding the consumers' identity, and often bear the full liability for fraud. These issuing banks could benefit from increased security, but they are not in a position to create change. There are approximately 1,600 issuing banks in the United States, and most consumers have cards from multiple banks.

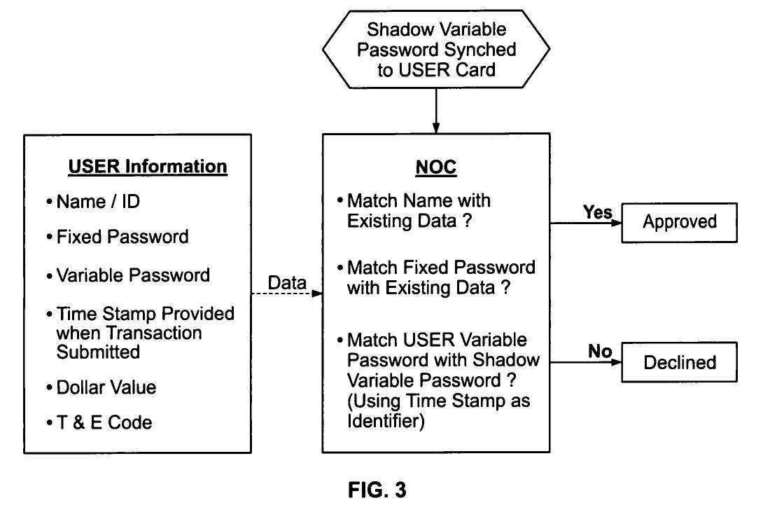

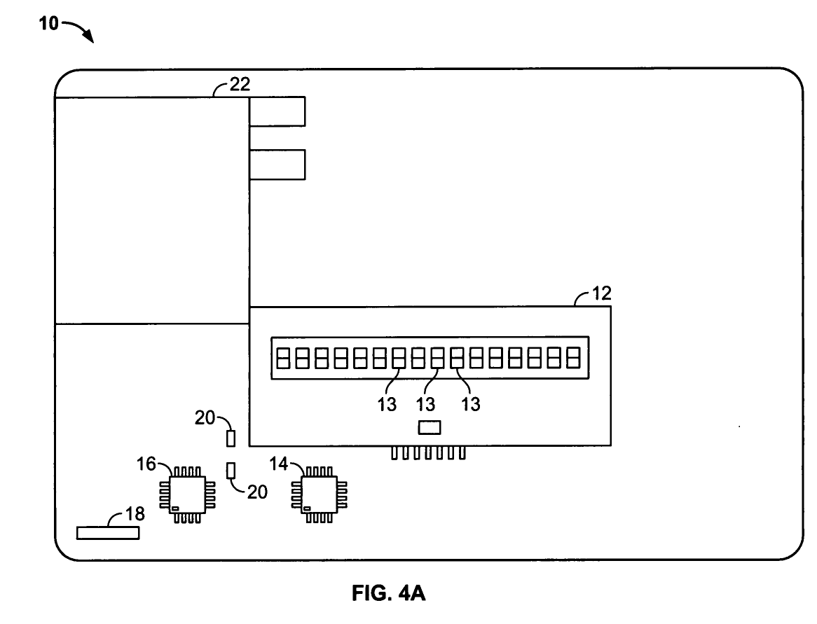

FIG. 2 is an exemplary schematic of a system for verifying user information, and therefore insulating and protecting issuing banks from consumer fraud. As seen in this embodiment, the user in this process, concurrently with making a purchase, submits identification and verification data to the retailer. This data is passed via the acquiring bank to the network operations center (hereinafter “NOC,” discussed in more detail below). The NOC is able to provide identification and verification authorization user existing, shadow, and provided data (see FIG. 3 for more details, below) before the transaction proceeds any further. If the user is positively identified and verified, the transaction may be allowed to proceed to the processor, and thereafter follows a similar path as seen in FIG. 1. If, however, the data submitted by the user do not effectuate a positive identification and verification of the user and/or the credit card or equivalent, the transaction may be voided, cancelled, declined, etc. In this embodiment, therefore, the user information is able to be identified and verified before the issuing bank approves any transaction, and allows the transaction to proceed back to the retailer.

FIG. 3 shows a more detailed schematic of the information a user provides under the current invention, and the resulting procedures at the NOC level that serve to identify and verify a user. When making a purchase, a user in this embodiment submits (1) the user name, (2) the fixed credit card password, (3) the variable credit card password, (4) the time-stamp header, (5) the T&E code, and (6) the dollar value of the purchase. All of this data may be packaged in an Internet Packet, which may remain intact until arriving at the NOC for disassembling and analysis.

The fixed credit card password may be any number of digits, and may preferably be the three-digit code that appears on the reverse side of many credit cards in use today. The T&E code is a Travel & Entertainment code, which are generally used by credit card companies to determine the category of goods being purchased. The time-stamp header on the packet provides the exact date and time the data was submitted by the user.

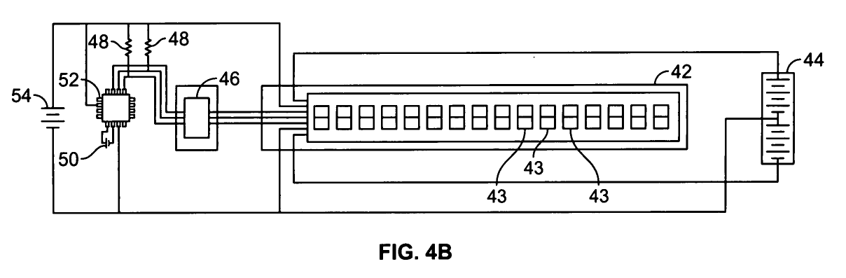

The variable credit card password may be generated by the credit card itself. An exemplary embodiment of a credit card in shown in FIG. 4A. Credit card 10 may have a display 12, processor 14, clock 16, and a crystal 18. Card 10 may also have resistors 20 and a battery element 22. Card 10 may be sized to approximate the dimensions of a normal credit card. In one embodiment, card 10 may have a length of about 85 mm, a width of about 55 mm, and a depth of about 1 mm. However, these dimensions are one of many combinations that may be preferable for card 10, as will be appreciated by those of skill in the art. Any or all of the elements of card 10 may be connected by way of a conductive material.

The display 12 preferably may be electronic display capable of display at least one numerical digit and/or other indicia 13, such as a letter or symbol. Display 12 may be able to provide indicia 13 in series. Preferably, display 12 is also capable of displaying indicia 13 that are variably displayed, as described in more detail herein. Indicia 13 may be generated by other components of card 10. In one embodiment, display 12 is capable of displaying sixteen (16) indicia in series at one time. However, it is expressly contemplated that the display 12 may be capable of displaying more or less than sixteen (16) indicia 13 at one time. Preferably, the number of indicia 13 displayed should be sufficient to make replication of the total display value difficult over a reasonable course of time. Each indicia 13 may also be comprised of more than one segment, such that a combination of segments comprises a single indicia 13.

Display 12 may be of the type manufactured by elnk™ (based in Cambridge, Mass.). Other suitable display 12 embodiments are known in the art. Preferably, display 12 is at least as thin as the credit card 10 itself. In one embodiment, has a thickness of about 0.7 mm. The thickness of display 12 may vary depending on the thickness of the credit card 10.

Processor 14 may be utilized to generate indicia 13 of the display 12. Processor 14 preferably may have relatively low power requirements to help maximize the life of battery 22. Processor 14 also may preferably be capable of supporting at least one encryption algorithm. Numerous algorithms are known in the art, such as AES (Advanced Encryption Method), RSA (Ron Rivest, Adi Shamir, and Len Adleman), Blowfish, SHA (Secure Hash Algorithm), DES, and elliptic curve. Processor 14 may also include at least one built-in security feature, such as tampering resistance, fingerprint identification system, and/or disguised processor activity. Processor preferably is sufficiently robust to generate indicia 13. In one embodiment, processor 14 is a MIPS32® 4KS™ Family core operating at 1.2V. Other types of processors are expressly contemplated, and will be appreciated by those of skill in the art. Processor 14 preferably is sized such it is at least as thin as the card 10 itself.

Clock 16 may be utilized to keep track of the date and time. Crystal 18 may be an oscillating crystal, and may be utilized to help ensure the accuracy of the date and time the clock 16 keeps track of. Preferably, crystal 18 oscillates at a specific frequency. Crystal 18 may be made of quartz, or a similar material. Clock 16 may also have an interrupt output provided by crystal 18, which may prompt the processor 14 to generate a different set of indicia 13 on the display 12. This interrupt output may occur at varying levels of frequency, and may have varying periods in between occurrences, but preferably occurs at least several times per day, and more preferably occurs about every 60 seconds. Specifically, the interrupt output may prompt the processor 14 to ascertain the date and time from the clock 16. The processor 14 may then generate new indicia 13 for the display 12 based at least in part on the date and time data provided by the clock 16. The processor 14 may be configured to enter a low-energy mode when between interrupt outputs provided by the clock 16. This may be beneficial in conserving the life of battery 22.

Battery element 22 may provide the requisite power for at least a portion of the components of card 10 to operate. Battery element 22 may be of the type produced by Front Edge Technologies™, or other types of batteries known in the art. Preferably, battery element 22 is significantly thinner than the thickness of the card 10. In one embodiment, battery element 22 has a thickness of about 0.2 mm. Battery element 22 may be disposed underneath another component of card 10, such as a logo. Battery element 22 may be comprised of a metal foil. Preferably, battery element 22 has a capacity of at least 100 microamp-hours at 32V. Battery element 22 may be rechargeable and also may be recyclable.

It is also expressly contemplated that more than one battery may be used to comprise battery element 22 (see FIG. 4B). Battery element 22 may also be comprised of a single battery. Further variations and combinations will be appreciated by those of skill in the art.

FIG. 4B shows the components, or variations thereof, of FIG. 4A in more detail. As seen in FIG. 4B, the credit card system may have a display 42 having indicia 43, a battery element comprising batteries 44 and 54, a processor 46, resistors 48, crystal 50, and clock 52. Display having indicia 43 may be substantially similar to display 12 having indicia 13 described above in relation to FIG. 4A. Processor 46, which may be substantially similar to processor 14 described above, may be connected to display 42. Battery 44 may be substantially similar to battery element 22. Battery 54 may be substantially similar to, but is preferably substantially different that batter 44. Preferably, battery 54 may be a 3.3 volt battery, but other capacities and characteristics will be appreciated. Resistors 48 may be substantially similar to resistors 20 described above, and clock 52 and crystal 50 may operate substantially similar to the operation of clock 16 and crystal 18, respectively.

In an exemplary method of use for the invention described herein, a card 10 is first issued to a user. The card 10 may be substantially similar to the embodiment described and shown in FIGS. 4A-4B, or may be a variation thereof. As discussed above, when the card 10 is issued, shadow data and other information is created and maintained in the NOC (see FIG. 3). In the instance of making a remote purchase, such as an Internet purchase, the user may enter (1) the variable password displayed on the display 12 of the card, and (2) a fixed password display on the card 10, and thereafter submit the purchase. This information may be accompanied by (1) a time-stamp header, which assigns a specific time and date to the user information submittal, (2) the T&E code, and (3) the dollar value for the purchase. All of this information may be packaged in a “packet,” and may be sent via a retailer and an acquiring bank to the NOC for processing (see FIG. 2).

It is important to note that the NOC may not pre-detect the presence of a variable password form a user before the NOC receives a packet. However, the NOC preferably may be able to determine whether or not a packet contains such data before diassembling such packet. Thus, if an NOC received a packet containing only a fixed credit card password, it preferably would not process such a packet, and instead send it directly to the processor, as seen in FIG. 2.

Upon receiving a packet having a variable password, the NOC may disassemble the packet into its parts, and process its data. The NOC may first retrieve the known information of the user using static information (such as the user's name and fixed password) to recall the variable password data concurrently maintained by the NOC as shadow data. In a preferred embodiment, the NOC may not maintain the displayed variable password on a user's card, but may instead maintain the hashing code (or other process) used to create the individual user's variable password, or authentication password. In such an embodiment, the information from the packet may be used to prompt the NOC to generate, via an authentication server, the variable password that should appear on the user's card matching the time and date provided on the time and date stamp in the packet. It also may be preferable to allow the NOC to run its authentication server both forwards and backwards. This may be preferable to enable the NOC to generate an accurate authentication password despite network delays or other discrepancies in the time the packet was submitted by the user, until it is received by the NOC. Overall, both variations are contemplated: the variable password data for a single card may be concurrently kept and maintained by the NOC, or may alternatively be generated on-demand by the NOC.

After the NOC generates its authentication password that should accompanying the time and date stamped with the packet, it may compare that password to the variable password provided by the user in the packet itself. If the authentication password and the variable password match, the transaction may be, and preferably is validated. The packet may then be reassembled by the NOC, and forwarded to processor (see FIG. 2), and then on to the issuing bank. If the authentication password and variable password do not match, the transaction is not validated. In this case, the refusal to validate information may be sent to another party.

In one embodiment, the NOC is comprised of multiple components, including a gateway system and a server processing system. The gateway system may serve to accept an http connection, and receive a user's variable password. The http connection preferably is time-stamped, consistent with the process described above. Once the http connection is established with the gateway system, the user's variable password and other information may be sent to the processing system for verification.

The processing system may preferably comprise triple redundant Beowulf clusters. Other processing system components may be preferable instead of or in addition to Beowulf clusters, but should have sufficient robustness and scalability to process numerous transactions in a short time period. Beowulf clusters are also preferable because of their ability to operate in near real-time.

The servers used in the above process may be located at a Class A data center. To sufficient accept and process high volumes of traffic, the servers should preferably possess a minimum of an OC-12 internet connection, approximately 622 Mbit/s, which should provide at least 600,000 simultaneous connections per second.

The above-described process should preferably take less than about 5 seconds in duration, and preferably less than about 3 seconds. For remote purchasing transactions, especially credit card transactions wherein it is preferable that authentication occur within a high proximity of the submission of the transaction, it is preferable that total transaction time is as fast as possible. Accordingly, it is preferable that the NOC be able to handle numerous transactions concurrently and reliably. Preferably, the NOC is able to respond and process data in less than about 2 second, and more preferably in less than about 1 second.

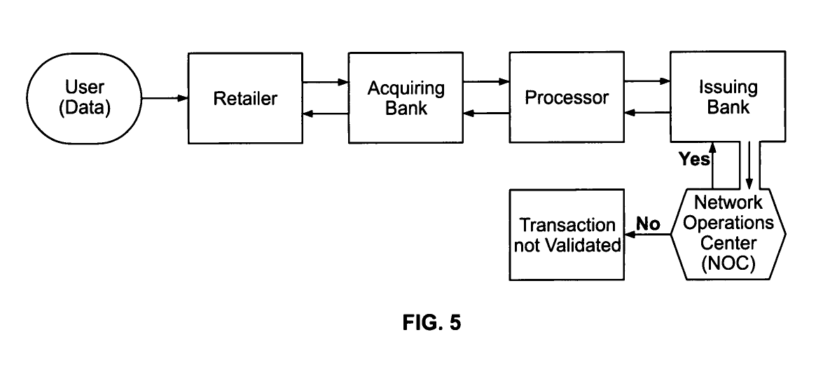

FIG. 5 is another embodiment of a user verification system that is similar to FIG. 2, but differs at least in the “location” of the NOC in the process. In this embodiment, the NOC may be built-in, or integral with the issuing bank, such that the NOC may provide a backstop for all incoming transactions utilizing a variable password. Any or all other characteristics of the system may be substantially similar to those described above.

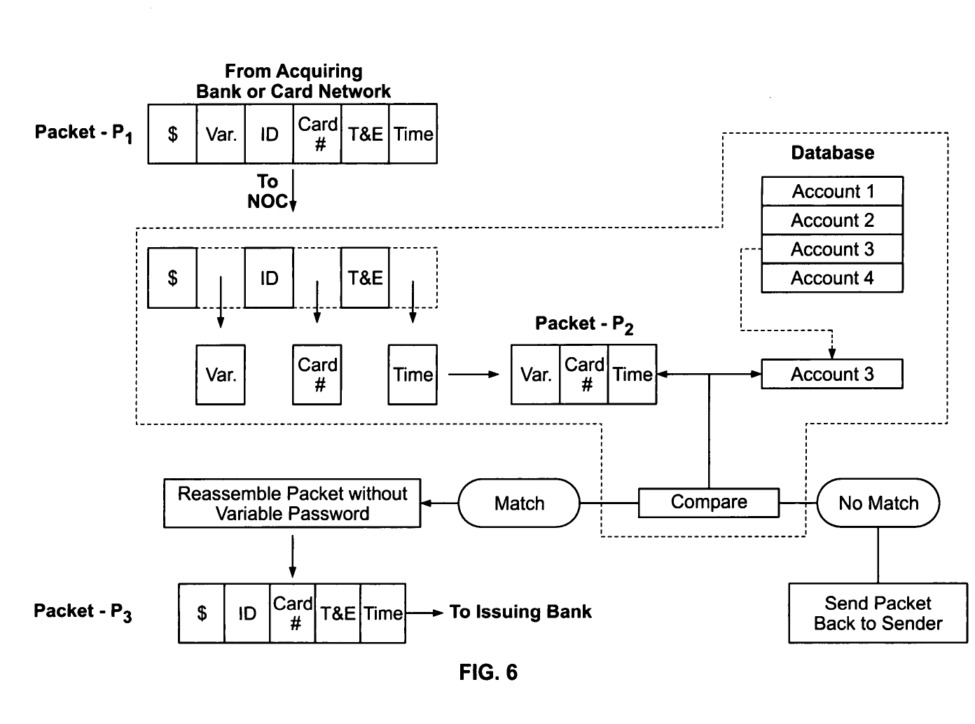

FIG. 6 is another embodiment of a user verificaiton system, focusing more closely on a packet of information. In this embodiment, the packet P₁ may comprise six components: the dollar amount ($), a variable password (var.), the name and/or address of the customer or user (ID), the card number or fixed password (card#), the Travel & Entertainment code (T&E), and the time/date stamp (time). Other variations are expressly contemplated, as a packet P₁ may have more or less components, and may be arranged in a variety of ways. As seen in its original, assembled form, packet P₁ may be coming from an acquiring bank or card network into an NOC. Upon entering the NOC, packet P₁ may be disassembled. In this embodiment, the variable password, card number/fixed password, and time/date stamp are separated from the packet P₁, and combined to form a smaller packet P₂. At this point, the user database of the NOC is searched for the known user information, and such data is retrieved for comparison with packet P₂. A comparison between packet P₂ and the user information from the NOC database may yield either of two results. First, if the information contained in packet P₂ and the retrieved user information match, the transaction may proceed. The packet may then be reassembled without variable password (var.) to form output packet P₃, which may be thereafter submitted to an issuing bank. Second, if the information contained in packet P₂ and the retrieved user information match, the transaction will be rejected, and packet P₁. may be sent back to the user/customer.

Variations of the system depicted in FIG. 6 are expressly contemplated. For instance, it may be preferable to reassemble the packet with the variable password (var.) before sending to an issuing bank. Also, it may be preferable to compare more, less, or different packet components other than the variable password, card number/fixed password, and time/date stamp.

It is expressly noted the systems and methods described above may have more than, or less than all of the steps and/or elements described herein. For example, the system in FIGS. 2 and 5 may or may not have a processor. In the case that the system would not have a processor, a card 10 could be pre-loaded with variable password indicia for the life of the card. In such an embodiment, the card 10 may only require a memory module, a clock, a battery, and a display unit. In this sense, the embodiments described herein are exemplary, and variations will be appreciated by those skilled in the art.

This written description sets forth the best mode of the claimed invention, and describes the claimed invention to enable a person of ordinary skill in the art to make and use it, by presenting examples of the elements recited in the claims. The patentable scope of the invention is defined by the claims themselves, and may include other examples that occur to those skilled in the art. Such other examples, which may be available either before or after the application filing date, are intended to be within the scope of the claims if they have elements that do not differ from the literal language of the claims, or if they include equivalent elements with insubstantial differences from the literal language of the claims.

While the invention has been shown and described herein with reference to particular embodiments, it is to be understood that the various additions, substitutions, or modifications of form, structure, arrangement, proportions, materials, and components and otherwise, used in the practice and which are particularly adapted to specific environments and operative requirements, may be made to the described embodiments without departing from the spirit and scope of the present invention. Accordingly, it should be understood that the embodiments disclosed herein are merely illustrative of the principles of the invention. Various other modifications may be made by those skilled in the art which will embody the principles of the invention and fall within the spirit and scope hereof.

What is claimed:

1. A method of verifying user information, comprising the steps of:
a. submitting the user information, wherein the user information comprises a variable password;
b. transmitting the user information to a processing server;
c. generating an authentication password based at least in part on provided information; and
d. comparing the variable password to the authentication password.

2. The method of claim 1, wherein step (c) is prompted by the processing server receiving the user information.

3. The method of claim 1, wherein the user information further comprises a fixed password.

4. The method of claim 1, wherein the user information further comprises a time/date stamp.

5. The method of claim 1, wherein the variable password is generated by a processor.

6. The method of claim 6, wherein the processor is housed in a credit card.

7. The method of claim 1, wherein the user information is submitted by a user remotely located from the processing server.

8. The method of claim 1, wherein the user information is at least partially comprised of information not processed by the processing server.

9. The method of claim 1, wherein the user information is submitted from a computer.

10. A method of verifying user information, comprising the steps of:
a. submitting the user information, wherein the user information comprises a variable password generated by a processor;
b. transmitting the user information to a processing server; and
c. comparing the variable password to an authentication password, wherein the authentication password is maintained independent of the processor.

11. The method of claim 10, wherein the user information further comprises a fixed password.

12. The method of claim 10, wherein the user information further comprises a time/date stamp.

13. The method of claim 10, wherein the processor is housed in a credit card.

14. The method of claim 10, wherein the user information is submitted by a user remotely located from the processing server.

15. The method of claim 10, wherein the user information is at least partially comprised of information not processed by the processing server.

16. The method of claim 10, wherein variable password and the authentication password are synched prior to step (a).

17. The method of claim 10, wherein the processor is connected to a clock configured to prompt the processor to generate a variable password.

18. The method of claim 17, wherein the clock prompts the processor at a first frequency.

19. The method of claim 18, wherein the authentication password is generated at the first frequency.

20. The method of claim 18, wherein the first frequency is predetermined.

21. The method of claim 10, wherein the user information is submitted from a computer.

22. A system for verifying user information, comprising:
a user element capable of generating a variable password;
a processing server capable of generating an authentication password based at least in part on provided information;
a connection configured to transmit the variable password to the processing server;
wherein the provided information comprises at least information correlating to the date and time a user transaction was submitted.

23. The system of claim 22, wherein the user element is a credit card.

24. The system of claim 22, wherein the user element comprises a processor.

25. The system of claim 22, wherein the authentication password is generated independent of the user element.

26. The system of claim 22, wherein the authentication password is generated upon the processing server receiving the variable password.

27. The system of claim 22, wherein the variable password and the authentication password are generated concurrently.

28. The system of claim 22, wherein the authentication password is stored in memory.

29. The system of claim 20, wherein the information correlating to the date and time a user transaction was submitted is provided by the user element.

30. A credit card comprising:
a display having a plurality of indicia;
a processor; and
a clock;
wherein the processor is connected to the display and the clock;
wherein the processor is capable of generating a variable password based at least in part on information provided by the clock; and
wherein the display is capable of displaying the variable password.

31. The credit card of claim 30, further comprising a crystal connected to the clock.

32. The credit card of claim 31, wherein the crystal oscillates at a substantially constant frequency.

33. The credit card of claim 32, wherein the clock is prompted to provide information to the processor based at least in part on the oscillation of the crystal.

34. The credit card of claim 30, further comprising at least one battery.

35. The credit card of claim 30, wherein the variable password is regenerated.
